(19) United States
(12) Patent Application Publication
(10) Pub. No.: US 2026/0280171 A1
(43) Pub. Date: Sep. 17, 2026

(54) POWER CONNECTOR WITH AN IMPROVED CONDUCTIVE ASSEMBLY

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/562,150

(22) Filed: Mar. 10, 2026

(30) Foreign Application Priority Data
Mar. 14, 2025 (CN) 202510307695.6

(51) Int. Cl. H01R 13/11; H01R 13/506; H01R 13/64

(52) U.S. Cl. CPC H01R 13/111; H01R 13/506; H01R 13/64

(57) ABSTRACT

A power connector incudes: a shell defining an inserted direction and having a mating face with a first inserted hole, a mounting face, and a first and a second space inside the shell; and a conductive assembly including a base received in the first space and restricted between the first and the second insides of the first space, and plural elastic arms. The base has a guiding passage aligned with the first inserted hole and gradually converges in the inserted direction; the elastic arms are arranged around the passage and extend into the second space; the base is able to move in a radial direction during inserting a plug into the guiding passage through the first inserted hole to press against the passage; and the elastic arms abut against the plug to establish a mechanical connection after the plug is inserted in the passage and the first and second spaces.

### BACKGROUND OF THE INVENTION

### 1. Field of the Invention

The present invention relates to a power connector with an improved conductive assembly.

### 2. Description of Related Arts

In devices such as servers, a plurality of pin-type plugs and a corresponding plurality of socket-type receptacles are provided to translate larger power currents. Typically, multiple plugs can be mounted on a same substrate and can be simultaneously mated with multiple receptacles. Due to possible installation position or dimensional errors during the manufacturing of the plugs and receptacles, the plugs may be misaligned with the mating passages in the receptacles during insertion. Therefore, how to reduce the impact of manufacturing errors on the mating between the plugs and receptacles remains an issue to be addressed in the related field. For example, U.S. Patent Application Publication No. 20240347942 discloses a power connector assembly including a first mating terminal, a bus bar, a first receptacle, and a position-limiting member.

An improved power connector is desired.

### SUMMARY OF THE INVENTION

An object of the present invention is to provide a power connector with an improved conductive assembly.

To achieve the above-mentioned object, a power connector adapted to be mounted on an external component for insertion and withdrawal of a power plug, comprises: a shell defining an inserted direction, the shell having a mating face with a first inserted hole, a mounting face opposite to the mating face and for being mounted on the external component, and a first space and a second space inside the shell, the first space having a first inside and a second inside perpendicular to the inserted direction; and a conductive assembly comprising a base received in the first space and restricted between the first inside and the second inside of the first space, and a plurality of elastic arms; wherein the base has a guiding passage aligned with the first inserted hole and gradually converges in the inserted direction; the elastic arms are arranged in a circumferential direction of the guiding passage and extend into the second space; the base is able to move in a radial direction perpendicular to the inserted direction during inserting the power plug into the guiding passage through the first inserted hole to press against the guiding passage; and the elastic arms abut against the power plug to establish a mechanical and electrical connection after the power plug is inserted in the guiding passage and the first and second spaces.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a power plug, a power connector, and an external component of an embodiment of the present application;

FIG. 2 is a perspective view of the power connector shown in FIG. 1;

FIG. 3 is a cross sectional view taken along line A-A of FIG. 2;

FIG. 4 is another perspective view of the power connector shown in FIG. 2;

FIG. 5 is a perspective view of a modified power connector;

FIG. 6 is an exploded perspective view of the power connector shown in FIG. 2;

FIG. 7 is an exploded view of a partial structure in FIG. 6; and

FIG. 8 is an enlarged view of a portion in the circle in FIG. 3.

### DETAILED DESCRIPTION OF THE PREFERRED EMBODIMENT

Reference will now be made to the drawing figures to describe a preferred embodiment of the present invention in detail.

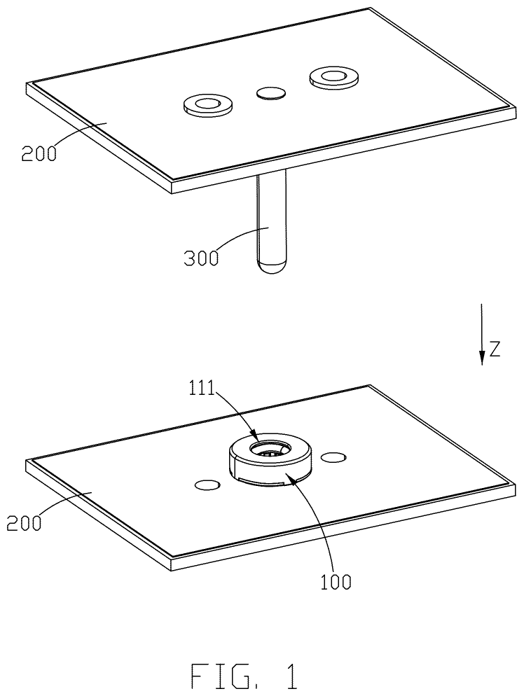

Referring to FIG. 1 illustrating a usage scenario of a power connector 100 of an embodiment of the present application, the power connector 100 is fixedly mounted on an external component 200, such as a circuit board, a copper bus bar, an aluminum bus bar, or the like, which is capable of transmitting power current. The power connector 100 is electrically connected to the external component 200 and is adapted for mating with a power plug 300. A first inserted hole 111 is formed on the power connector 100, and the power plug 300 can be inserted into the first inserted hole 111 along an inserted direction Z, so that the power plug 300 is electrically connected to the power connector 100. The power plug 300 can also be withdrawn from the first inserted hole 111 in a direction opposite to the inserted direction Z. Similarly, the power plug 300 can be fixedly mounted on the external component 200. The specific manner of a fixation manner is not particularly limited. For example, the fixation manner can include, but is not limited to, welding fixation, integrally formed fixation, snap-fit fixation, and screw fixation. The direction in which the power plug 300 is inserted into the first inserted hole 111 is defined as the inserted direction Z. As shown in FIG. 1, the inserted direction Z has opposite first side and second side, the first side faces the power plug 300 while the second side is disposed away from the power plug 300. The first inserted hole 111 is formed on the first side of the power connector 100.

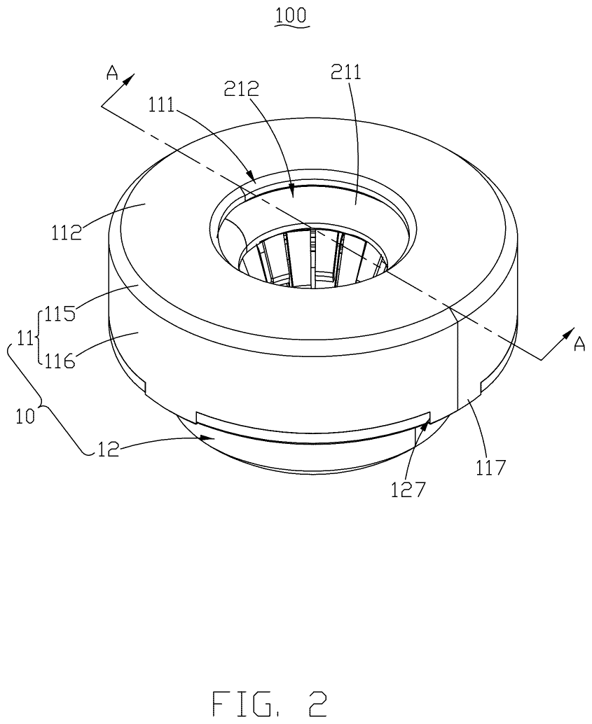

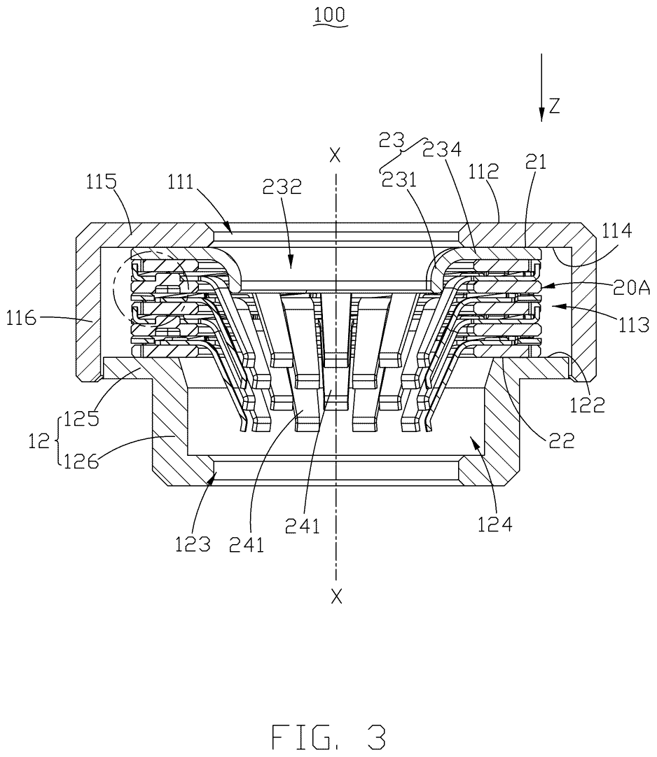

Referring to FIGS. 2-3, the power connector 100 includes a shell 10 and a conductive assembly 20. The shell 10 has a mating face 112 and a mounting face 121 opposite to the mating face 112. The mounting face 121 is fixed to the external component 200. The mating face 112 has the first inserted hole 111, and the second side of the shell 10 also a second inserted hole 123 through both two the power plug 300 is inserted. The first inserted hole 111 and the second mating hole 123 are opposite to each other in the inserted direction Z. A first space 113 and a second space 124 are formed inside the shell 10. The first inserted hole 111, the first space 113, the second space 124, and the second inserted hole 123 are sequentially arranged along the inserted direction Z and are in communication with each other. Therefore, the shell has a mating axis X-X as shown in FIG. 3, the mating axis X-X is parallel to the inserted direction Z. The first space 113 is in communication with the first inserted hole 111, and the second space 124 is in communication with the first space 113 and the second inserted hole 123. The first space 113 has a first inside 114 and a second inside 122, which are perpendicular to the inserted direction Z. The first space 113 is close to the first inserted hole 111. That is, the first space 113 is larger than the second space 124 in a radial direction perpendicular to the mating axis X-X.

The conductive assembly 20 includes a base 20A and a plurality of elastic arms 241. The base 20A is accommodated in the first space 113 and is restricted between the first inside 114 and the second inside 122. A gap is formed between a peripheral edge of the base 20A and a circumferential inside of the first space 113, that is, the base 20A is spaced apart from the circumferential inside of the first space 113 in the radial direction thereof. A guiding passage 232 is formed on the base, and the guiding passage 232 is aligned and communicates with the first inserted hole 111 and the second inserted hole 123. A cross-section of the guiding passage 232 is circular. The guiding passage 232 gradually converges in the inserted direction Z, that is, the diameter of the guiding passage 232 gradually decreases in the inserted direction Z. The power plug 300 is inserted into the guiding passage 232 through the first inserted hole 111, and then into the second space 124 and the second inserted hole 123, so that the power plug 300 is mated with the power connector 100 to establish a mechanical and electrical connection. When the power plug 300 is inserted into the guiding passage 232, the power plug 300 abuts against the guiding passage 232 to drive the base 20A to move in the radial direction perpendicular to the inserted direction. The plurality of elastic arms 241 are arranged in a circumferential direction of the guiding passage 232 and extend into the second space 124. The elastic arms 241 abut against the power plug 300 to establish the mechanical and electrical connection after the power plug 300 is completely inserted.

The conductive assembly 20 can be made of a conductive metal material, for example, a copper alloy. The elastic arms 241 are electrically connected to the base 20A. The base 20A has a ring-shaped cross-section. Similarly, the shell 10 has a ring-shaped cross-section. The axial direction of the base 20A coincides with the axial direction of the shell 10, and both coincide with the inserted direction. The first inside 114 and the second inside 122 limit the base 20A to restrict the movement of the base 20A in the inserted direction Z. The inside of the guiding passage 232 can be an inclined surface or an arc surface, so as to gradually contract in the inserted direction.

When the guiding passage 232 is misaligned with the power plug 300, the power plug 300 abuts against the inside of the guiding passage 232 during the mating process with the power connector 100. The inside of the guiding passage 232 guides the base 20A to move in the radial direction, so that the guiding passage 232 can gradually align with the power plug 300, allowing the power plug 300 to pass through the guiding passage 232 to achieve electrical connection with the power connector 100. Therefore, the influence of dimensional and mounting position errors of the power connector 100 and the power plug 300 during the inserted process can be reduced, and the convenience and stability of the connection between the power plug 300 and the power connector 100 can be improved.

The shell 10 includes a cover 11 and a seat 12. The cover 11 includes a first plate 115 and a first tubular 116. The first inserted hole 111 is formed on the first plate 115. The mating face 112 is located on the first side of the first plate 115. The first tubular 116 extends from the first plate or is fixedly connected to the first plate 115, and then extends in the inserted direction. The first tubular 116 surrounds the outer side of the base 20A. The diameter of the first tubular 116 is greater than the diameter of the base 20A, so that a gap is formed between the peripheral edge of the base and the inside of the first tubular 116. The first space 113 is located inside the cover 11, and the second side of the first plate 115 forms the first inside 114.

The seat 12 includes a second plate 125 and a second tubular 126. The second plate 125 is fixedly connected to the first tubular 116, so that the cover 11 is connected to the base 20A. The first space 113 is formed between the first plate 115 and the second plate 125. The first side of the second plate 125 forms the second inside 122 while the second side forms the mounting face 121. The diameter of the second plate 125 can be equal to the diameter of the first tubular 116. The second tubular 126 extends from the second plate 125 or is fixedly connected to the second plate 125, and then extends opposite to the inserted direction Z. The second space 124 is formed inside the second tubular 126. The diameter of the second tubular 126 is less than the diameter of the second plate 125. The second inserted hole 123 is formed on the second side of the second tubular 126.

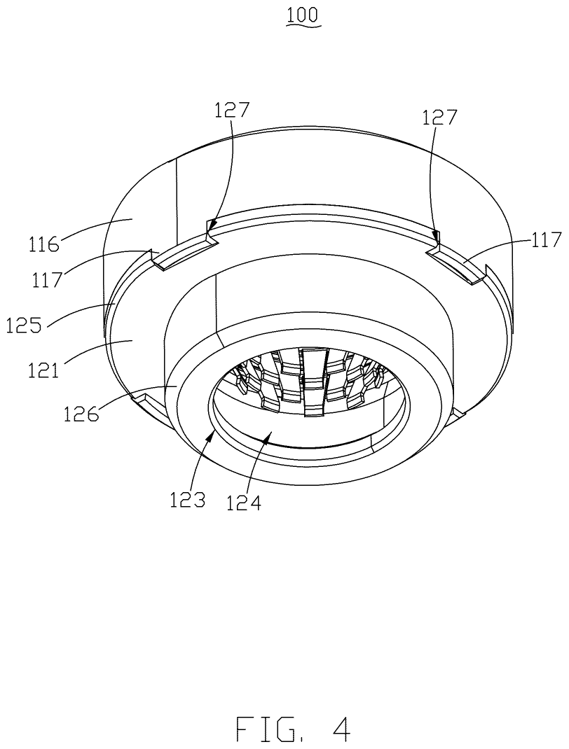

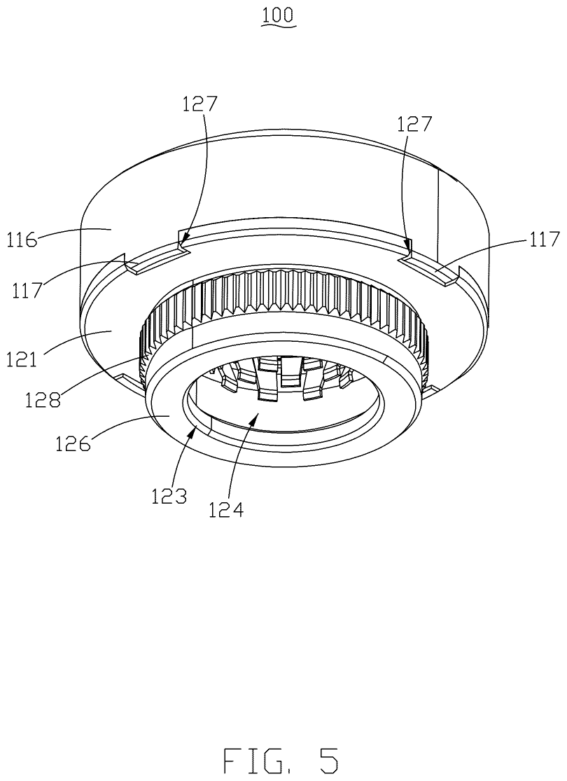

As clearly shown in FIGS. 4-5, a plurality of retaining portions 117 extend from the first tubular 116. The retaining portions 117 are spaced apart in the circumferential direction and are all fixedly connected to the first tubular 116. A plurality of locking slots 127 are formed on the peripheral edge of the second ring 242. The locking slots 127 are spaced apart in the circumferential direction and correspond to the retaining portions 117 one by one. The retaining portions 117 can be inserted into the corresponding locking slots 127, so that the retaining portions 117 are locked to the second plate 125. It can be understood that the retaining portions 117 are fixed with the locking slots 127 by interference, so as to achieve a fixed connection between the seat 12 and the cover 11.

Referring to FIG. 4, the shell 10 is fixedly connected to the external component 200 by soldering. At this time, the retaining portions 117 protrude from the second side of the second plate 125 in the inserted direction Z. The second tubular 126 penetrates the external component 200, and the second side of the retaining portions 117 abuts against the external component 200, so that a gap is formed between the mounting face 121 on the second plate 125 and the external component 200. Solder can pass through this gap and connect the mounting face 121 and the external component 200.

Referring to FIG. 5 showing a modified power connector, the shell 10 is fixedly connected to the external component 200 by interference fit. The second sides of the retaining portions 117 are flush with the mounting face 121, and the mounting face 121 abuts against the external component 200. An interference pattern 128 is protruded on the peripheral wall of the second tubular 126. The second tubular 126 penetrates the external component 200, and the interference pattern 128 can be interference-fitted with the external component 200, so as to achieve fixed connection between the shell 10 and the external component 200.

The base 20A has a first plane 21, a second plane 22, and a guiding ring 231. The first plane 21 and the second plane 22 are respectively located on the first side and the second side of the base 20A in the inserted direction Z. The first plane 21 can be matched and abutted with the first inside 114 of the first space 113, and the second plane 22 can be matched and abutted with the second inside 122 of the first space 113. The guiding ring 231 is fitly connected to the first plane 21, and the guiding ring 231 extends in the inserted direction Z. The guiding passage 232 is formed in the guiding ring 231.

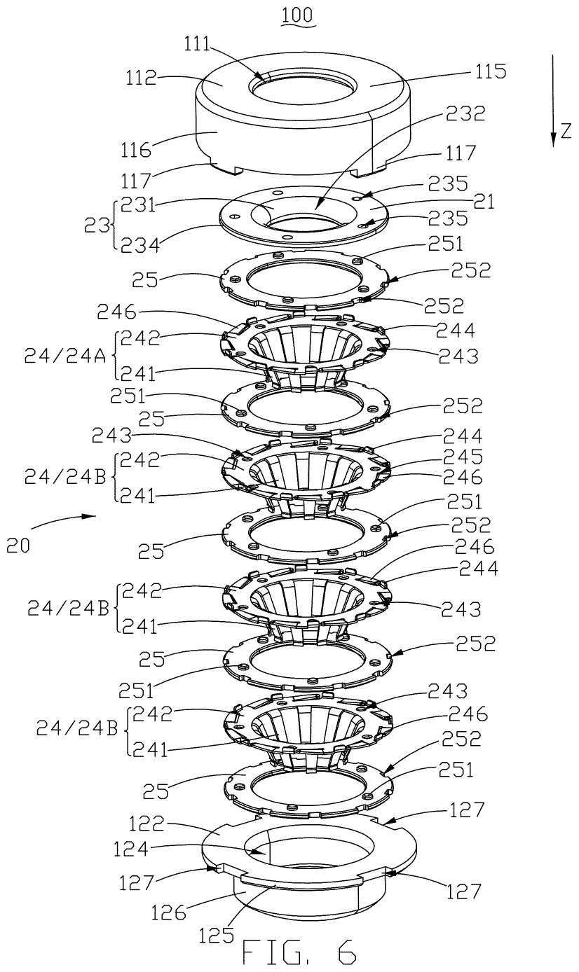

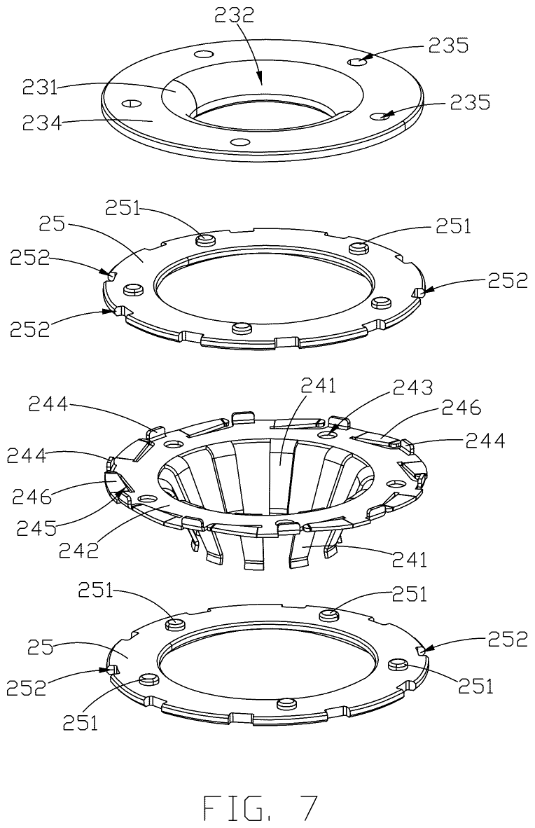

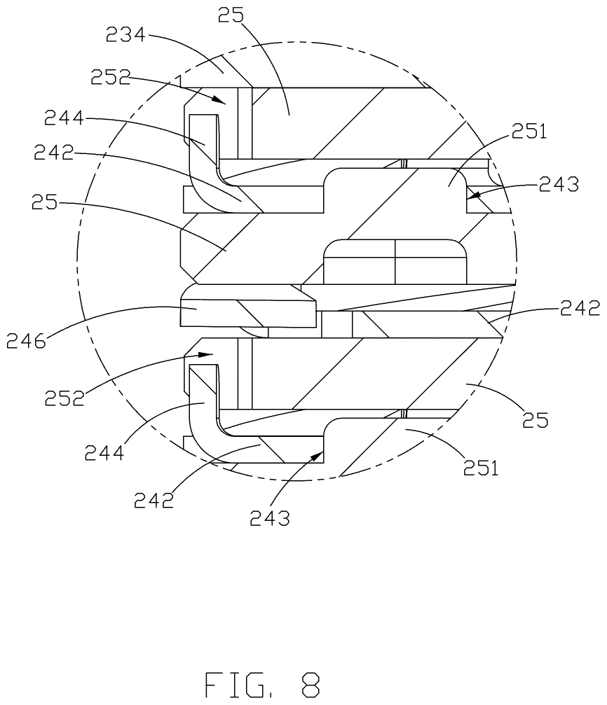

Referring to FIGS. 6 to 8, the conductive assembly 20 includes a guiding member 23 and at least one abutment member 24. The guiding member 23 includes a first ring 234 and a guiding ring 231 extending from an inner edge of the first ring 234 in the inserted direction Z. The first plane 21 is formed on the first side of the first ring 234. The abutment member 24 includes a second ring 242 and a plurality of elastic arms 241 extending from an inner edge of the second ring 242. The second ring 242 and the first ring 243 are stacked and retained together in the inserted direction Z, to form the base 20A. That is, the first ring 234 can be connected to the second ring 242.

In this embodiment, a fixing ring 25 is sandwiched between the first ring 234 and the second ring 242 to assembly the conductive assembly 20. The fixing ring 25 has a plurality of fixing protrusions 251 protruding therefrom and spaced apart in the circumferential direction and located on the first side of the fixing ring 25. A plurality of first fixing holes 235 are formed on the first ring 234. The first fixing holes 235 penetrate the first ring 234 in the inserted direction Z and are spaced apart in the circumferential direction. The fixing protrusions 251 can be inserted to the first fixing holes 235 to retain the fixing ring 25 to the guiding member 23.

The fixing ring 25 has a plurality of limiting openings 252 formed on a peripheral edge thereof and spaced apart in the circumferential direction. A plurality of lugs 244 are formed by bending a peripheral portion of the second ring 242, and each lug 244 extends in the direction opposite to the inserted direction Z. The plurality of lugs 244 can be inserted into the plurality of limiting openings 252 on the fixing ring 25 so as to enhance the fixation between the fixing ring 25 and the abutment member 24.

The second ring 242 further has a plurality of second fixing holes 243 penetrate the corresponding second ring 242 and are spaced apart in the circumferential direction. One more fixing ring 25 is attached to the second ring 242, the protrusions 251 can be inserted and retained in the second fixing holes 243 to retain the abutment member 24.

It can be understood, plural abutment members 24 can be disposed to increase the number of the elastic arms 241 and to increase the strength of the base 20A. In this embodiment, the number of abutment members 24 can be plural, and the plurality of abutment members 24 can be arranged in the inserted direction. The number of fixing rings 25 can be plural, and the plurality of fixing rings 25 can be arranged in the inserted direction. One second ring 242 can be disposed between every two adjacent fixing rings 25, and one fixing ring 25 can be disposed between every two second rings 242. The side of each second ring 242 facing the second inside 122 is connected to a corresponding fixing ring 25. Among the plurality of fixing rings 25, the fixing ring 25 on the first side is located between the first ring 234 and the closet second ring 242 to the first ring 234, and abuts against the second side of the first ring 234. The fixing ring 25 on the second side is located between the second inside 122 and the closes second ring 242 to the second inside 122, and abuts against the second inside 122, with the second plane 22 formed on the second side of this fixing ring 25. Each fixing ring 25 can be connected to the adjacent first ring 234 and/or second ring 242, so that the first ring 234, all second rings 242, and all fixing rings 25 can cooperate to form the base 20A.

The number of fixing rings 25 can be defined as N, where N is an integer greater than one. The number of abutment members 24 is N−1. The N fixing rings 25 are sequentially arranged in the inserted direction from the first fixing ring 25 to the Nth fixing ring 25. The first fixing ring 25 is located between the first ring 234 and the second ring 242 closest to the first ring 234, and the Nth fixing ring 25 is located between the second inside 122 and the second ring 242 closest to the second inside 122. The embodiments of the present application can be exemplified by the case where N equals 5.

The plurality of fixing protrusions 251 can correspond one-to-one with the plurality of first fixing holes 235, and each fixing protrusion 251 can penetrate the corresponding first fixing hole 235, so as to achieve fixation between the first fixing ring 25 and the guiding member 23. The guiding ring 231 can penetrate the hollow portion of the first fixing ring 25 and the hollow portion of the first second ring 242 in the inserted direction. The first fixing ring 25 can abut against the second side of the first ring 234 and the first side of the second ring 242 closest to it.

The second fixing ring 25 to the Nth fixing ring 25, the plurality of fixing protrusions 251 can correspond one-to-one with the plurality of second fixing holes 243 on the second ring 242 that is closest to and located on the first side of the fixing ring 25. Each fixing protrusion 251 can penetrate the corresponding second fixing hole 243, so as to achieve fixation between the fixing ring 25 and the abutment member 24 that is closest to and located on the first side of the fixing ring 25. The plurality of elastic arms 241 on each abutment member 24 can pass through the hollow portion of the fixing ring 25 that is closest to and located on the second side of the second ring 242 of the abutment member 24.

The plurality of limiting openings 252 can be formed on the peripheral portion of each fixing ring 25, and the plurality of limiting openings 252 can be spaced apart in the circumferential direction. The plurality of lugs 244 are formed by bending the peripheral portion of each second ring 242, and each lug 244 extends in the direction opposite to the inserted direction. The plurality of lugs 244 can be inserted into the plurality of limiting openings 252 on the fixing ring 25 that is closest to and located on the first side of the second ring 242, so as to enhance the fixation between the fixing ring 25 and the adjacent abutment member 24. In this way, from the first fixing ring 25 to the (N−1)th fixing ring 25, each limiting opening 252 receives a corresponding lug 244. The second side of each second ring 242 is connected to an adjacent fixing ring 25, and the first side of each second ring 242 is connected to another adjacent fixing ring 25.

Please notes, every two adjacent abutment members 24 are placed offset. That is, seen in the inserted direction, the lugs 244 of one abutment member are offset from the lugs 244 of another abutment member. The tabs 246 have the same structure. The elastic arms 241 of one abutment member are staggered with the elastic arms of another abutment member in the circumferential direction, and the elastic arms 241 of one abutment member is located behind the elastic arms of another abutment member in the inserted direction.

In another way, the abutment members 24 can be divided in to a first abutment member 24A as shown in FIG. 4 and plural second abutment member 24B shown in FIG. 4, the second rings of the second abutment members 24B and the second ring of the first abutment member 24A are stacked with the first abutment member in the mating axis X-X, the elastic arms of the second abutment members are located inside the elastic arms of the first abutment members. The elastic arms of the second abutment members extend beyond the elastic arms of the first abutment members in the mating axis.

As the power plug 300 continues to move from the first side toward the second side, the elastic arm 241 of one abutment member 24 can firstly scrape off stains on the power plug 300, thereby reducing the probability of poor contact caused by another abutment members 24 abutting against stains on the power plug 300, and improving the stability of the connection between the power plug 300 and the power connector 100.

In some embodiments, a plurality of notches 245 are formed on the peripheral edge of each second ring 242, and the plurality of notches 245 are spaced apart in the circumferential direction. A plurality of tabs 246 are fixedly connected to the peripheral edge of each second ring 242, and each tab 246 is fixedly connected to the inside of the corresponding notch 245. Each tab 246 is bent away from the inserted direction and abuts against the fixing ring 25 that is closest to and located on the first side of the second ring 242, so that the second ring 242 is spaced apart from the fixing ring 25 abutting against the tab 246. Meanwhile, the thickness of each fixing protrusion 251 in the inserted direction, can be less than the thickness of the corresponding second ring 242.

It can be understood that when the power plug 300 abuts against the plurality of elastic arms 241, the power plug 300 can apply pressure to the abutment members 24 in the inserted direction. At this time, at least some of the fixing rings 25 in the conductive assembly 20 can press the tabs 246, so that at least some adjacent second rings 242 and fixing rings 25 are brought closer together. After being pressed, the tabs 246 can undergo elastic deformation and buffer the pressure applied by the power plug 300, thereby reducing the probability of damage to the conductive assembly 20 caused by the mating of the power plug 300. Meanwhile, the elastic force generated by the elastic deformation of the plurality of tabs 246 can drive the first ring 234 closer to the first inside 114, and drive the Nth fixing ring 25 closer to the second inside 122, so that the first plane 21 and the second plane 22 of the base 20A can respectively maintain close contact with the first inside 114 and the second inside 122, enabling the conductive assembly 20 to remain fixed to the shell 10 when no power plug 300 is inserted.

When the fixing protrusion 251 abuts against the corresponding second ring 242, the fixing ring 25 cannot further press the tab 246 on the corresponding second ring 242. In this way, it is possible to avoid excessive pressing of the tab 246 on the second ring 242 by the adjacent fixing ring 25 when the conductive assembly 20 is compressed under pressure, thereby preventing the tab 246 from undergoing plastic deformation. This reduces the probability that the first inside 114 and the second inside 122 cannot clamp the conductive assembly 20 due to damage to the tab 246, and improves the service life of the power connector 100.

When the power plug 300 is mated with the power connector 100, the second side of the power plug 300 can abut against the inside of the guiding ring 231. Through the guidance of the guiding ring 231 and the pushing of the power plug 300, the conductive assembly 20 can be driven to move in the radial direction, thereby adjusting the position of the base 20A so that the guiding passage 232 can move from a position misaligned with the power plug 300 to a position aligned with the power plug 300. As the power plug 300 moves, it can pass through the guiding passage 232 and maintain abutment with the plurality of elastic arms 241, thereby achieving electrical connection between the power plug 300 and the power connector 100.

By limiting the base 20A with the first inside 114 and the second inside 122, the conductive assembly 20 can remain fixed when the guiding passage 232 is aligned with the power plug 300, while when the power plug 300 and the guiding passage 232 are misaligned, the conductive assembly 20 can be moved by the pushing of the power plug 300 so as to align the conductive assembly 20 with the power plug 300. In this way, the influence of dimensional and mounting position errors of the power connector 100 and the power plug 300 on the mating between the power plug 300 and the power connector 100 can be reduced, and the convenience and stability of the connection between the power plug 300 and the power connector 100 can be improved.

The above-mentioned embodiments are only preferred embodiments of the present invention, and should not limit the scope of the present invention, any simple equivalent changes and modifications made according to the claims of the present invention and the contents of the description should still belong to the present invention.

1. A power connector adapted to be mounted on an external component for insertion and withdrawal of a power plug, comprising:
a shell defining an inserted direction, the shell having a mating face with a first inserted hole, a mounting face opposite to the mating face and for being mounted on the external component, and a first space and a second space inside the shell, the first space having a first inside and a second inside perpendicular to the inserted direction; and
a conductive assembly comprising a base received in the first space and restricted between the first inside and the second inside of the first space, and a plurality of elastic arms; wherein
the base has a guiding passage aligned with the first inserted hole and gradually converges in the inserted direction;
the elastic arms are arranged in a circumferential direction of the guiding passage and extend into the second space;
the base is able to move in a radial direction perpendicular to the inserted direction during inserting the power plug into the guiding passage through the first inserted hole to press against the guiding passage; and
the elastic arms abut against the power plug to establish a mechanical and electrical connection after the power plug is inserted in the guiding passage and the first and second spaces.

2. The power connector as claimed in claim 1, wherein the base has a first plane and a guiding ring, the first plane matches with the first inside, the guiding ring is connected to the first plane and extends in the inserted direction, and the guiding passage is formed in the guiding ring.

3. The power connector as claimed in claim 2, wherein the guiding ring protrudes beyond roots of the elastic arms connected to the base in the inserted direction.

4. The power connector as claimed in claim 1, wherein the shell has a second inserted hole opposite to the first inserted hole in the inserted direction.

5. The power connector as claimed in claim 1, wherein the shell comprises:
a cover comprising a first plate and a first tubular extending from the first plate in the inserted direction, the first inserted hole being formed on the first plate; and
a seat comprising a second plate and a second tubular extending from the second plate and connected to the first tubular, the first space being formed between the first plate and the second plate, the second space being formed inside the second tubular.

6. The power connector as claimed in claim 1, wherein the conductive assembly comprises:
a guiding member comprising a first ring and a guiding ring extending from the first ring in the inserted direction, the guiding passage being formed inside the guiding ring; and
at least one abutment member comprising a second ring, the elastic arms extending from the second ring, the first ring and the second ring being retained together to form a part of the base of the conductive assembly.

7. The power connector as claimed in claim 6, wherein:
the conductive assembly comprises at least one fixing ring sandwiched between the first ring and the second ring;
the at least one fixing ring has a plurality of fixing protrusions and a plurality of limiting openings;
the first ring has a plurality of first fixing holes, and the second ring has a plurality of lugs along a circumferential edge thereof; and
the fixing protrusions are inserted and retained in corresponding first fixing holes, and the limiting openings receive corresponding lugs.

8. The power connector as claimed in claim 7, wherein:
the conductive assembly comprises a plurality of fixing rings sequentially arranged in the insertion direction, a respective abutment member is disposed between every two adjacent fixing rings, a side of the at least one second ring facing the second inside is connected to a corresponding fixing ring;
a plurality of second fixing holes are formed on the second ring, each fixing protrusion is inserted into the corresponding second fixing hole, and each limiting opening receives a corresponding lug; and
a thickness of the fixing protrusion is less than a thickness of the second ring.

9. The power connector as claimed in claim 7, wherein the second ring has a plurality of tabs slanting and abutting against the at least one fixing ring.

10. The power connector as claimed in claim 5, wherein the first tubular has a plurality of retaining portions extending therefrom and locked with the second plate.

11. A power connector comprising:
a shell defining a mating axis, the shell having a mating face with a first inserted hole, a mounting face opposite to the mating face, and a first space and a second space inside the shell, the first space being larger than the second space in a radial direction perpendicular to the mating axis and having a first inside and a second inside perpendicular to the mating axis; and
a conductive assembly comprising a base received in the first space and restricted between the first inside and the second inside of the first space, and a plurality of elastic arms;
wherein the base has a guiding passage aligned with the first inserted hole and gradually converging towards the mating axis and away from the mating face, and the elastic arms extend from the base and protrude into the second space across the first space.

12. The power connector as claimed in claim 11, wherein:
the conductive assembly comprises:
a guiding member comprising a first ring and a guiding ring extending from the first ring away from the mating face, the guiding passage being formed inside the guiding ring; and
an abutment member comprising a second ring, the elastic arms extend from the second ring; and
the first ring and the second ring are stacked and retained together in the mating axis to form the base of the conductive assembly.

13. The power connector as claimed in claim 12, wherein the conductive assembly further comprises two fixing rings, a first fixing ring of the two fixing rings is sandwiched between the first ring and the second ring, and a second fixing ring of the two fixing rings is attached to the second ring.

14. The power connector as claimed in claim 13, wherein the second ring has a plurality of tabs slanting towards the mating face, and the tabs press against the first fixing ring.

15. The power connector as claimed in claim 11, wherein:
the conductive assembly comprises:
a guiding member comprising a first ring and a guiding ring extending from the first ring in the mating axis, the guiding passage being formed inside the guiding ring; and
a plurality of abutment members each comprising a second ring and the elastic arms extending from the second ring; and
the first ring and the second rings are stacked and retained together in the mating axis to commonly form at least a part of the base of the conductive assembly.

16. The power connector as claimed in claim 15, wherein the elastic arms of the abutment members are staggered in the mating axis.

17. A power connector comprising:
a shell defining a mating axis, the shell having a mating face with a first inserted hole and a first space defined thereinside, the first space having a first inside and a second inside perpendicular to the mating axis; and
a conductive assembly comprising a guiding member and a first abutting member; wherein
the guiding member comprises a first ring and a guiding ring extending from the first ring away from the mating face;
the first abutment member comprises a second ring and a plurality of elastic arms extending from the second ring; and
the first ring and the first second ring are stacked and retained together in the mating axis and commonly floatably received in the first space, the guiding ring is aligned with the inserted holes in the mating axis, and the elastic arms are disposed along a circumferential direction of the guiding ring and each extend slantwise away from the mating face and towards the mating axis.

18. The power connector as claimed in claim 17, wherein the guiding ring protrudes away from the mating face and beyond roots of the elastic arms.

19. The power connector as claimed in claim 18, wherein the conductive assembly further comprise a second abutment member, the second abutment member comprises a second ring and plural elastic arms, the second rings of the second abutment members and the second ring of the first abutment member are stacked with the first abutment member in the mating axis, and the elastic arms of the second abutment members are located inside the elastic arms of the first abutment members.
